(19) United States
(12) Patent Application Publication
(10) Pub. No.: US 2010/0325676 A1
(43) Pub. Date: Dec. 23, 2010

(54) SYSTEM FOR TRANSMITTING/RECEIVING DIGITAL REALISTIC BROADCASTING BASED ON NON-REALTIME AND METHOD THEREFOR

(75) Inventors: Sung-Hoon Kim, Daejon (KR); Jong Soo Lim, Daejon (KR); Soo-In Lee, Daejon (KR); Kug-Jin Yun, Daejon (KR); Hyoungsoo Lim, Daejon (KR); Yang-Su Kim, Daejon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTIT, Daejon (KR)

(21) Appl. No.: 12/517,867

(22) PCT Filed: Dec. 7, 2007
(86) PCT No.: PCT/KR2007/006354

§ 371 Date: Jun. 5, 2009

(30) Foreign Application Priority Data
Dec. 8, 2006 (KR) 10-2006-0125152
Oct. 9, 2007 (KR) 10-2007-0101672

(51) Int. Cl. H04N 7/173

(52) U.S. Cl. 725/105

(57) ABSTRACT

Provided are a transmitting and receiving system for non-realtime based digital realistic broadcasting, and a method thereof. The transmitting system includes a broadcasting TS generator for generating a 2-D TS for a 2-D image and an auxiliary TS for auxiliary information necessary for realistic broadcasting of the 2-D image, and a transmitter for transmitting the generated auxiliary transport stream before a corresponding broadcasting time and transmitting the generated 2-D transport stream according to a corresponding broadcasting schedule.

### TECHNICAL FIELD

The present invention relates to a transmitting and receiving system for non-realtime based digital realistic broadcasting, and a method thereof; and, more particularly, to a transmitting and receiving system for non-realtime based digital realistic broadcasting and a method thereof, which enable to maintain a low-level compatibility with an existing 2-D digital broadcasting transmitting and receiving system and to prevent the image quality of 2-D broadcasting from deteriorating, which caused by the transmission of realistic broadcasting auxiliary information such as auxiliary information for 3-D broadcasting or for high definition broadcasting.

This work was supported by the Information Technology (IT) research and development program of the Korean Ministry of Information and Communication (MIC) and/or the Korean Institute for Information Technology Advancement (IITA) [2006-S-016-01, “Development of Distributed Translator Technology for Terrestrial DTV”].

### BACKGROUND ART

Conventionally, a three dimensional (3-D) moving image has been serviced based on a digital realistic broadcasting transmitting system and method according to the related art.

A transmitting side transmits a multiplexed digital signal with a packet identifier (PID) for identifying a left image signal and a right image signal as well as another PID for identifying video data or audio data. Then, a receiving side separates left image information and right image information, which are included in received image information as auxiliary information and alternatively displays the separated left image information and the separated right image information, thereby providing further realistic 3-D image through TV that was used to display 2-D images.

In the related art, two different PID values were defined for left image information and right image information. That is, two video streams were generated. Due to such a reason, an existing 2-D system could not identify a left image stream and a right image stream. That is, such 3-D image technology according to the related art is not compatible to the existing 2-D system.

In order to generate a 3-D moving image, image information for two images with different viewpoints, one viewpoint image and a disparity map, or one viewpoint image and a depth map. However, a conventional technology only teaches about two images and fails to teach the others.

As described above, the digital realistic broadcasting transmitting and receiving system according to the related art was not compatible with an existing 2-D digital broadcasting transmitting system. The digital realistic broadcasting transmitting and receiving system according to the related art also deteriorates the quality of 2-D images of primary broadcasting due to the transmission of the 3-D auxiliary information.

### DISCLOSURE OF INVENTION

### Technical Problem

An embodiment of the present invention is directed to providing a transmitting and receiving system for non-realtime based digital realistic broadcasting and a method thereof, which enable to maintain a low-level compatibility with an existing 2-D digital broadcasting transmitting and receiving system and to prevent the image quality of 2-D broadcasting from deteriorating, which caused by the transmission of realistic broadcasting auxiliary information such as auxiliary information for 3-D broadcasting or for high definition broadcasting.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a non-realtime digital realistic broadcasting transmitting system including: a broadcasting transport stream (TS) generation unit for generating a two dimensional (2-D) transport stream (TS) for a 2-D image and an auxiliary transport stream (TS) for auxiliary information necessary for realistic broadcasting of the 2-D image; and a transmission unit for transmitting the generated auxiliary transport stream before a corresponding broadcasting time and transmitting the generated 2-D transport stream according to a corresponding broadcasting schedule.

In accordance with another aspect of the present invention, there is provided a non-realtime digital realistic broadcasting transmitting system including: a broadcasting transport stream generation unit for generating a two dimensional (2-D) image transport stream (TS); and a transmission unit for transmitting the generated 2-D transport stream according to a corresponding broadcasting schedule, and receiving an auxiliary transport stream for auxiliary information necessary for realistic broadcasting of the 2-D image from an external device and transmitting the received auxiliary transport stream before a corresponding broadcasting time.

In accordance with still another aspect of the present invention, there is provided a non-realtime based digital realistic broadcasting receiving system including: a restoration unit for receiving a digital broadcasting signal and restoring the received digital broadcasting signal; and a realistic image generation unit for storing auxiliary information necessary for realistic broadcasting of a two dimensional (2-D) image before a corresponding broadcasting time and generating a realistic image using the stored auxiliary information and the restored 2-D image when the 2-D image is restored according to a broadcasting schedule at the restoration unit.

In accordance with further another aspect of the present invention, there is provided a method for transmitting digital realistic broadcasting based on a non-realtime, comprising the steps of: generating a transport stream (TS) for broadcasting data; and transmitting an auxiliary information transport stream necessary for realistic broadcasting of a two dimensional (2-D) image before a corresponding broadcasting time and transmitting the generated transport stream according to a broadcasting schedule.

In accordance with yet another aspect of the present invention, there is provided a method for receiving digital realistic broadcasting based on a non-realtime, including the steps of: storing auxiliary information necessary for realistic broadcasting before a corresponding broadcasting time; restoring a corresponding two dimensional (2-D) image from a predetermined broadcasting signal when predetermined broadcasting of the auxiliary information is received; and generating a realistic image using the restored auxiliary information and the restored 2-D image.

### ADVANTAGEOUS EFFECTS

Non-realtime based digital realistic broadcasting transmitting and receiving system according to the present invention transmit and receive AV data and auxiliary information based on a DTV/DMB MPEG-2 system. That is, a transmitting side transmits auxiliary information for realistic broadcasting in advance to a receiving side at a residual time or through a residual stream. The receiving side receives and stores the auxiliary information in a local storage. Then, the receiving side reads the auxiliary information from the local storage and restores a realistic image by synchronizing a 2-D image with the read auxiliary information.

Therefore, the present invention guarantees a low level compatibility with an existing 2-D digital broadcasting transmitting system and prevents the quality of 2-D images from deteriorating.

That is, the present invention enables a user having a conventional digital broadcasting receiver to enjoy 2-D images without image quality deterioration although the user receives realistic broadcasting contents such as 3-D image broadcasting contents. Also, the present invention enables a user having a realistic broadcasting receiver to enjoy high quality 2-D or 3-D images broadcasting.

### BRIEF DESCRIPTION OF THE DRAWINGS

FIG. 1 is a diagram illustrating a non-realtime based digital 3-D broadcasting transmitting system in accordance with an embodiment of the present invention.

FIG. 2 is a diagram illustrating a non-realtime based digital 3-D broadcasting transmitting system in accordance with an embodiment of the present invention.

### BEST MODE FOR CARRYING OUT THE INVENTION

The present invention relates to a digital realistic broadcasting system for transmitting realistic images such as a 3-D image and a high definition image to a user in order to enable a user to enjoy the solidity of an image and the high definition image using a non-realtime personal video recorder (PVR) scheme. The present invention may be applicable to various digital broadcasting schemes such a digital multimedia broadcasting (DMB) scheme and a digital television broadcasting scheme.

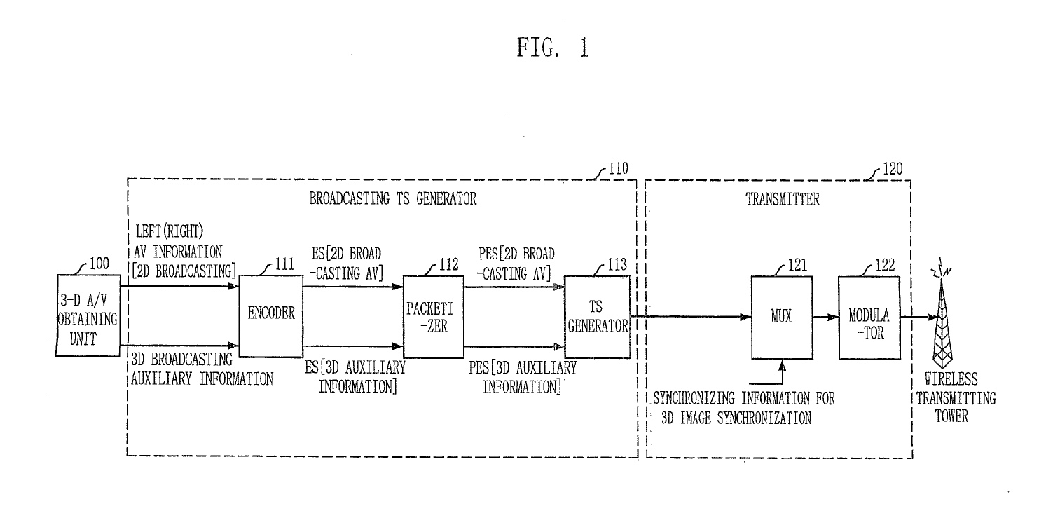

The non-realtime based digital realistic broadcasting transmitting system according to an embodiment of the present invention includes a digital 3-D transmitting system and a digital 3-D receiving system. As shown in FIG. 1, the digital 3-D transmitting system according to the present embodiment transmits auxiliary information for producing a 3-D image to a receiving side in advance using a residual time and a residual stream such as Null packets based on a MPEG-2 system which is currently used for digital broadcasting, independently from an original 2-D video transport stream.

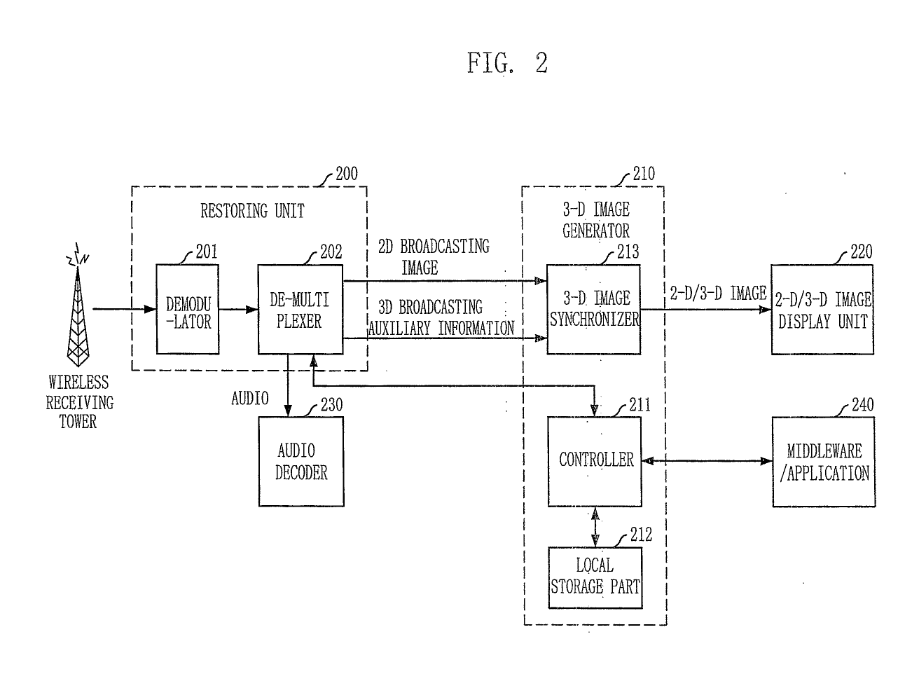

The digital 3-D broadcasting receiving system shown in FIG. 2 stores 3-D auxiliary information that is previously received from the digital 3-D broadcasting transmitting system in a local storage part. When the digital 3-D broadcasting receiving system receives a primary broadcasting signal which is a 2-D TV signal at a broadcasting time, the digital 2-D broadcasting receiving system reads the previously stored 3-D auxiliary information and reproduces the 3-D image by synchronizing the read 3-D auxiliary information with the 2-D original broadcasting signal. That is, the 3-D broadcasting receiving system reads previously stored 3-D auxiliary information from a local storage unit when the 3-D broadcasting system receives the 2-D broadcasting signal, synchronizes the read 3-D auxiliary information with the 2-D broadcasting signal, and reproduces a 3-D image.

The technology for transmitting and receiving 3-D auxiliary information according to the present invention can be identically applied to auxiliary information that are necessary for various realistic broadcasting such as high definition broadcasting.

The non-realtime based digital 3-D broadcasting transmitting and receiving system guarantee a low level compatibility with an existing 2-D digital broadcasting transmitting system. Since it is not required to allocate a predetermined time or a data slot in a primary broadcasting for transmitting auxiliary data, the non-realtime base digital 3-D broadcasting transmitting and receiving system according to the present invention does not deteriorate the quality of a 2-D image for providing 3-D realistic broadcasting such as 3-D digital broadcasting and high definition broadcasting.

The advantages, features and aspects of the invention will become apparent from the following description of the embodiments with reference to the accompanying drawings, which is set forth hereinafter.

In the present invention, a transmitting side transmits realistic broadcasting auxiliary information to a receiving side in advance before a related 2-D image is transmitted. A receiving side stores the realistic broadcasting auxiliary information received in advance from the transmitting side or inputted from the other input unit. When primary broadcasting starts, the receiving side reproduces realistic images using the stored auxiliary information after restoring 2-D images. Here, the realistic broadcasting means the next generation digital broadcasting including 3-D broadcasting, high definition broadcasting, and sensing broadcasting. The realistic broadcasting auxiliary information means auxiliary information necessary for the next digital broadcasting. Hereinafter, 3-D broadcasting among the realistic broadcasting will be described as an embodiment of the present invention.

FIG. 1 is a diagram illustrating a non-realtime based digital 3-D broadcasting transmitting system in accordance with an embodiment of the present invention. That is, FIG. 1 shows the configuration and the operation of a digital 3-D broadcasting transmitting system which is one type of the digital realistic broadcasting transmitting system according to the present embodiment.

Hereinafter, a method for transmitting 3-D broadcasting, which is performed in a digital 3-D broadcasting transmitting system according to the present embodiment, will be described together.

As shown in FIG. 1, the digital 3-D broadcasting transmitting system according to the present embodiment includes a 3-D AV obtaining unit 100, a broadcasting TS generator 110, and a transmitter 120.

The 3-D AV obtaining unit 100 obtains left and right audio/video information for 2-D broadcasting and auxiliary information for 3-D broadcasting from 3-D contents. Here, the left and right audio/video information for 2-D broadcasting will be referred as 2-D AV information, and the auxiliary information for 3-D broadcasting will be referred as 3-D auxiliary information. In another embodiment, the 3-D auxiliary information may input through various on/offline input units such as the Internet and a USB memory and is used for a non-realtime DTV service.

Here, the 3-D auxiliary information is information for producing a 3-D image. For example, the 3-D auxiliary information is auxiliary information for producing a 3-D image in a 3-D TV service of DTV/DMB. The 3-D auxiliary information may be an image of the other view point from 2-D broadcasting image (hereinafter 2-D image). That is, if the 2-D image is a left image, the 3-D auxiliary information is a right image. On the contrary, if the 2-D image is a right image, the 3-D auxiliary information is a left image. The 3-D auxiliary information may be a disparity map, and a depth map.

Then, the broadcasting TS generator 110 generates TS streams (TS) individually for the AV information and the 3-D auxiliary information inputted from the 3-D AV obtaining unit 100. In more detail, the broadcasting TS generator 110 includes an encoder 111, a packetizer 112, and a TS generator 113.

The encoder 111 generates elementary streams for AV information and 3-D auxiliary information by individually encoding the AV information including audio data and 2-D image and the 3-D auxiliary information, which are inputted from the 3-D AV obtaining unit 100.

Here, a MPEG-2 encoder may be used as the encoder 111. Or, an encoder having an excellent compression rate may be used among widely used encoding schemes according to information to encode, for example, MPEG-4 AVC for auxiliary information.

Meanwhile, the present invention can be applied to non-realtime digital broadcasting based ultra high definition TV (UDTV). In this case, scalable video CODEC (SVC) base layer audio/video (AV) is equivalent to the AV information, and auxiliary information necessary for the UDTV broadcasting is equivalent to the 3-D auxiliary information. For example, SVC enhancement layer auxiliary information is the 3-D auxiliary information for the UDTV broadcasting. The SVC enhancement layer auxiliary information is used to reproduce high quality image by interworking with the SVC Base Layer information.

The packetizer 112 generates a packetized elementary stream (PES) by packetizing 2-D AV elementary streams (ES) and 3-D auxiliary elementary stream (ES) from the encoder 111.

The TS generator 113 generates a transport stream (TS) for the PES outputted from the packetizer 112. That is, the TS generator 113 outputs 2-D AV TS, which is audio TS and 2-D image TS, and 3-D auxiliary information TS.

Then, the transmitter 120 transmits the 3-D auxiliary information TS in advance before a corresponding broadcasting time and transmits the 2-D AV TS according to a predetermined broadcasting schedule. The transmitter 120 includes a multiplexer (MUX) 121 and a modulator 122.

The MUX 121 multiplexes the 2-D AV TS, the 3-D auxiliary information TS, and synchronizing information for 3-D image synchronization, and transmits the multiplexed signal to a receiving side through the modulator 122. Here, the 3-D auxiliary TS is transmitted at a residual time or using a residual data transport stream such as a NULL packet in advance. The residual time means a time that TV broadcasting is not serviced. That is, the residual time may be a time after the TV broadcasting ends and before the TV broadcasting starts. That is, the 3-D auxiliary TS is transmitted before a corresponding broadcasting time. Unlikely, the 2-D AV TS is transmitted to the receiving side according to the corresponding broadcasting schedule. Here, the multiplexed 3-D auxiliary information and synchronizing information for 3-D image synchronization are information used for reproducing 3-D images.

In the present embodiment shown in FIG. 1, the 3-D auxiliary information is inputted to the encoder 111 and processed through the TS generator 113. However, 3-D auxiliary information may be directly inputted to the multiplexer 121 through “data broadcasting” without inputting to the encoder 111. That is, the multiplexer 121 may independently receive 3-D auxiliary information TS through “data broadcasting” and transmit the 3-D auxiliary information TS to a receiving side in advance.

The modulator 122 modulates the multiplexed TS from the multiplexer 121 based on a digital broadcasting specification and transmits the modulated signal to a receiving side.

FIG. 2 is a diagram illustrating a non-realtime based digital 3-D broadcasting receiving system in accordance with an embodiment of the present invention. That is, FIG. 2 shows the configuration and the operation of a digital 3-D broadcasting receiving system which is one type of the digital realistic broadcasting receiving system according to the present embodiment.

Hereinafter, a method for receiving 3-D broadcasting, which is performed in a digital 3-D broadcasting receiving system according to the present embodiment, will be described together.

As shown in the digital 3-D broadcasting receiving system according to the present embodiment includes a restoring unit 200, a 3-D image generator 210, a 2-D/3-D image display unit 220, an audio decoder 230, and a middleware/application 240.

The restoring unit 200 receives a digital broadcasting signal and restores 2-D image, 3-D auxiliary information, and synchronizing information for 3-D image. The restoring unit 200 includes a demodulator 201 and a de-multiplexer (DeMux) 202.

At first, the demodulator 201 demodulates a digital broadcasting signal received through an antenna to a transport stream (TS).

The de-multiplexer 202 separates a 2-D TS, an audio TS, a 3-D auxiliary information TS, and a synchronizing information TS from the TS inputted from the demodulator 201. The separated transport streams (TS) are de-packetized to an elementary stream (ES) and decoded again. That is, the de-multiplexer 202 obtains a 2-D TS, an audio TS, a 3-D auxiliary information TS, and a synchronizing information TS from the TS.

Here, the 3-D auxiliary information is obtained from a transport stream transmitted at a residual time where a primary broadcasting is not serviced or a transport stream for residual data. The obtained 3-D auxiliary information is stored in the local storage part 212.

The 3-D image generator 210 may be a realistic image generator. The 3-D image generator 210 stores the 3-D auxiliary information restored before a corresponding broadcasting time through the restoring unit 200 and generates 3-D image using the stored 3-D auxiliary information and 2-D image. The 3-D image generator 210 includes a control logic part 211, a local storage part 212, and a 3-D image synchronizer 213.

The controller 211 controls the de-multiplexing operation of the de-multiplexer 202. If 3-D auxiliary information is recognized by analyzing a TS packet, the 3-D auxiliary information is stored in the local storage part 212, and the corresponding information is registered at the middleware of a broadcasting receiver or an application 240.

The controller 211 also determines whether a 3-D image will be reproduced in later according to a request of a user or not. If a user or a broadcasting station requests to reproduce a 3-D image, the controller 211 reproduces a 3-D image. When it is required to reproduce a 3-D image, a 2-D image is received and processed according to a broadcasting schedule, and the controller 211 is informed that the 2-D image is received and processed. Then, the controller 211 reads corresponding 3-D auxiliary information from the local storage part 212 and transfers the read 3-D auxiliary information to the 3-D image synchronizer 213. That is, the controller 211 reads the previously stored 3-D auxiliary information from the local storage part 212 when the primary broadcasting signal is received and transfers the read 3-D auxiliary information to the 3-D image synchronizer 213.

Furthermore, the controller 211 controls the generation of the 3-D image from the 3-D image synchronizing unit 202 using the synchronizing information for 3-D image synchronization, which is extracted from the de-multiplexer 202.

The 3-D image synchronizer 213 bypasses the 2-D image inputted from the demultiplexer 202 or reproduces a 3-D image by synchronizing the 2-D image and the 3-D auxiliary information from the de-multiplexer 202 and outputs the reproduced 3-D image to the 2-D/3-D image display unit 220.

That is, the 3-D image synchronizer 213 confirms a display type inputted from a user. If the display type is the display of a 2-D image, the 3-D image synchronizer 213 ignores the 3-D auxiliary information and bypasses an original image such as 2-D image to the 2-D/3-D image display unit 220. If a display type requested by a user is the display of a 3-D image, the 3-D image synchronizer 213 generates a 3-D image by synchronizing the 2-D image with the 3-D image auxiliary information based on the synchronizing information for 3-D image synchronization and outputs the generated 3-D image to the 2-D/3-D image display unit 220.

In the process of generating a 3-D image, 3-D auxiliary information formed of the odd field images and the even field images of a video signal are mixed line by line, thereby generating a SD level 3-D image. Here, garbage data included in the 3-D auxiliary information is ignored. Also, the resolution of the 3-D image varies according to the characteristics of an image display unit such as a monitor. Accordingly, an enlargement and reduction module may be included for enlarging and reducing a video signal when the video signal is displayed.

For example, the 3-D image synchronizer 213 uses a proper 3-D image generation algorithm according to the type of 3-D auxiliary information such as a right image, a left image, a disparity map, and a depth map.

In the 3-D image generation process, it is important to accurately synchronize the 2-D image such as a left image and the 3-D auxiliary information such as a right image in a frame unit in order to improve the solidity of an image while reducing a visual stress of a user.

The 2-D/3-D image display unit 220 displays a 2-D image or a 3-D image received from the 3-D image synchronizer 213. The audio decoder 230 reproduces an audio stream received from the de-multiplexer 202.

The controller 211 synchronizes the 2-D image or the 3-D image outputted from the 3-D image synchronizer 213 to the 2-D/3-D image display unit 220 with the audio outputted from the audio decoder 230.

In the present embodiment, the digital 3-D broadcasting receiving system according to the present embodiment obtains the 3-D auxiliary information transmitted through a broadcasting network, and stores and uses the obtained 3-D auxiliary information to generate a 3-D image. However, the digital 3-D broadcasting receiving system may receive the 3-D auxiliary information through the Internet or from the other units such as a USB memory, store the received 3-D auxiliary information in the local storage part 212, and use the stored 3-D auxiliary information in another embodiment.

The 3-D broadcasting was described as an example of the realistic broadcasting in the present embodiment. However, the present invention is not limited thereto. The present invention may be applied to transmit, receive, and process auxiliary information necessary for various types of realistic broadcasting such as high definition (HD) TV or ultra high definition (UD) TV.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application Nos. 2006-0125152 and 2007-0101672, filed in the Korean Intellectual Property Office on Dec. 8, 2006, and Oct. 9, 2007, respectively the entire contents of which are incorporated herein by reference.

While the present invention has been described with respect to certain preferred embodiments, it will be apparent to those skilled in the art that various changes and modifications may be made without departing from the spirits and scope of the invention as defined in the following claims.

1. A non-realtime digital realistic broadcasting transmitting system comprising: a broadcasting transport stream (TS) generation means for generating a two dimensional (2-D) transport stream (TS) for a 2-D image and an auxiliary transport stream (TS) for auxiliary information necessary for realistic broadcasting of the 2-D image; and
a transmission means for transmitting the generated auxiliary transport stream before a corresponding broadcasting time and transmitting the generated 2-D transport stream according to a corresponding broadcasting schedule.

2. The non-realtime digital realistic broadcasting transmitting system of claim 1, wherein the transmission means transmits a synchronizing information transport stream (TS) for realistic image synchronization by multiplexing the synchronizing information transport stream (TS) with the 2-D image transport stream (TS).

3. The non-realtime digital realistic broadcasting transmitting system of claim 1, wherein the auxiliary information includes at least one of three dimensional (3-D) auxiliary information for 3-D broadcasting, high definition (HD) auxiliary information for HD broadcasting, and sensory information for sensory broadcasting.

4. The non-realtime digital realistic broadcasting system of claim 1, wherein the transmission means transmits the auxiliary transport stream to a receiving side at a residual time where a primary broadcasting is not serviced.

5. The non-realtime digital realistic broadcasting system of claim 1, wherein the transmission means transmits the auxiliary transport stream (TS) to a receiving side using a residual data transport stream.

6. The non-realtime digital realistic broadcasting transmitting system of claim 1, further comprising an auxiliary information obtaining means for obtaining the 2-D image and the auxiliary information from digital broadcasting contents.

7. A non-realtime digital realistic broadcasting transmitting system comprising:
a broadcasting transport stream generation means for generating a two dimensional (2-D) image transport stream (TS); and
a transmission means for transmitting the generated 2-D transport stream according to a corresponding broadcasting schedule, and receiving an auxiliary transport stream for auxiliary information necessary for realistic broadcasting of the 2-D image from an external device and transmitting the received auxiliary transport stream before a corresponding broadcasting time.

8. The non-realtime digital realistic broadcasting transmitting system of claim 7, wherein the transmission means transmits a synchronizing information transport stream (TS) for realistic image synchronization by multiplexing the synchronizing information transport stream (TS) with the 2-D image transport stream (TS).

9. The non-realtime digital realistic broadcasting transmitting system of claim 7, wherein the auxiliary information includes at least one of three dimensional (3-D) auxiliary information for 3-D broadcasting, high definition (HD) auxiliary information for HD broadcasting, and sensory information for sensory broadcasting.

10. The non-realtime digital realistic broadcasting system of claim 7, wherein the transmission means transmits the auxiliary transport stream to a receiving side at a residual time where a primary broadcasting is not serviced.

11. The non-realtime digital realistic broadcasting system of claim 7, wherein the transmission means transmits the auxiliary transport stream (TS) to a receiving side using a residual data transport stream.

12. A non-realtime based digital realistic broadcasting receiving system comprising:
a restoration means for receiving a digital broadcasting signal and restoring the received digital broadcasting signal; and
a realistic image generation means for storing auxiliary information necessary for realistic broadcasting of a two dimensional (2-D) image before a corresponding broadcasting time and generating a realistic image using the stored auxiliary information and the restored 2-D image when the 2-D image is restored according to a broadcasting schedule at the restoration means.

13. The non-realtime based digital realistic broadcasting receiving system of claim 12, wherein the restoration means includes:
a demodulation means for receiving the digital broadcasting signal and demodulates the received digital broadcasting signal to a transport stream (TS); and
a de-multiplexing means for obtaining the 2-D image, the auxiliary information and synchronizing information necessary for synchronizing an realistic image from the transport stream (TS).

14. The non-realtime based digital realistic broadcasting receiving system of claim 13, wherein the de-multiplexing means obtains the auxiliary information from a transport stream transmitted at a residual time where a primary broadcasting is not service or a residual bit transport stream.

15. The non-realtime based digital realistic broadcasting receiving system of claim 13, wherein the realistic image generation means includes:
a control means for storing auxiliary information obtained before a corresponding broadcasting time through the de-multiplexing means, transferring the obtained auxiliary information according when a corresponding broadcasting starts and controlling a process of generating a realistic image using the obtained synchronizing information from the de-multiplexing means; and
an image synchronizing means for bypassing a 2-D image from the demultiplexing means or generating a realistic image by synchronizing the 2-D image with the auxiliary information according to a display type request from a user.

16. The non-realtime based digital realistic broadcasting receiving system of claim 12, wherein the realistic image generation means receives the auxiliary information from an external device, stores the received auxiliary information, and uses the stored auxiliary information for generating the realistic image.

17. The non-realtime based digital realistic broadcasting receiving system of claim 12, wherein the auxiliary information includes at least one of three dimensional (3-D) auxiliary information for 3-D broadcasting, high definition (HD) auxiliary information for HD broadcasting, and sensory information for sensory broadcasting.

18. A method for transmitting digital realistic broadcasting based on a non-realtime, comprising the steps of:
generating a transport stream (TS) for broadcasting data; and
transmitting an auxiliary information transport stream necessary for realistic broadcasting of a two dimensional (2-D) image before a corresponding broadcasting time and transmitting the generated transport stream according to a broadcasting schedule.

19. The method of claim 18, wherein the broadcasting data includes the 2-D image and auxiliary information necessary for realistic broadcasting of the 2-D image, which are obtained from digital broadcasting contents, and
the auxiliary information transport stream is a auxiliary information transport stream generated in the generating a transport stream.

20. The method of claim 18, wherein the auxiliary information transport stream is auxiliary information transport stream received from an external device.

21. The method of claim 18, wherein in the transmitting an auxiliary information transport stream, the auxiliary information transport stream is transmitted to a receiving side at a residual time where a primary broadcasting is not serviced.

22. The method of claim 19, wherein in the transmitting an auxiliary information transport stream, the auxiliary information transport stream is transmitted to a receiving side using a residual data transport stream.

23. A method for receiving digital realistic broadcasting based on a non-realtime, comprising the steps of:
storing auxiliary information necessary for realistic broadcasting before a corresponding broadcasting time;
restoring a corresponding two dimensional (2-D) image from a predetermined broadcasting signal when predetermined broadcasting of the auxiliary information is received; and
generating a realistic image using the restored auxiliary information and the restored 2-D image.

24. The method of claim 23, wherein the auxiliary information is obtained from a transport stream transmitted through a broadcasting network at a residual time where primary broadcasting is not serviced or from a residual bit transport stream transmitted through a broadcasting network.

25. The method of claim 23, wherein the auxiliary information is auxiliary information inputted through an external input means of a receiving side.
